(19) United States
(12) Patent Application Publication
(10) Pub. No.: US 2012/0121490 A1
(43) Pub. Date: May 17, 2012

(54) Method For Sorption of Carbon Dioxide Out Of Flue Gas

(75) Inventors: Roland Kalb, Leoben (AT); David Wappel, Pinggau (AT); Stefan Pecharda, Tulln (AT); Günter Gronald, Zeltweg (AT)

(73) Assignee: AE&E AUSTRIA GMBH & CO KG, Raaba/Graz (AT)

(21) Appl. No.: 13/380,416

(22) PCT Filed: Jun. 22, 2010
(86) PCT No.: PCT/EP2010/058849

§ 371 Date: Feb. 2, 2012

Related U.S. Application Data
(60) Provisional application No. 61/220,388, filed on Jun. 25, 2009.

(51) Int. Cl. B01D 53/62; B01D 47/02; B01D 53/74

(52) U.S. Cl. 423/223; 423/220; 423/226; 423/234; 422/168; 95/236; 261/119.1

(57) ABSTRACT

According to an exemplary aspect of the invention a method of sorption of CO₂ out of flue gas is provided, wherein the method comprises contacting the flue gas and an ionic liquid comprising an anion and a non-aromatic cation.

### TECHNICAL FIELD

The invention relates to a method for sorption of CO₂ out of flue gas. Further, the invention relates to a device for sorption of CO₂ out of flue gas.

### BACKGROUND

When burning a combustible, e.g. oil, gas or coal, a number of exhaust gases are produced which together forms flue gas. Some of the exhaust gases have some negative effects on the environment. Some of these exhaust gases are sulphur oxides, nitrogen oxides or carbon dioxide. For example, the produced sulphur dioxide leads to acid rain, while carbon dioxide (CO₂) which is produced in great amount during these burning processes, is one main reason for climate change. Some processes to remove such disadvantageous gases from flue gases are known and performed to some extent, e.g. sulphur oxides and nitrogen oxide are removed or filtered out of flue gases.

However, the known processes of removal CO₂ out of flue gas may be costly.

### SUMMARY

It may be an objective of the invention to provide a method of removal of CO₂ and a device for removal of CO₂ from flue gases which method may be safe to use or less expensive than known methods.

This object may be solved by a method for sorption of CO₂ out of flue gas and a device for sorption of CO₂ out of flue gas according to the independent claims. Further exemplary embodiments are described in the dependent claims.

According to an exemplary aspect of the invention a method or sorption of CO₂ out of flue gas is provided, wherein the method comprises contacting the flue gas and an ionic liquid comprising an anion and a non-aromatic cation. Furthermore, it should be noted that the term “contacting” may particularly denote any process allowing the two components brought in contact to react with each other.

The sorption may be an adsorption or an absorption. The ionic liquid may be a pure ionic liquid, i.e. a liquid substantially only containing anions and cations, while not containing other components, e.g. water. Alternatively a solution containing the ionic liquid and a solvent or further compound, e.g. water, may be used. For example, the content of other components than the ionic liquid may be 35% or less by mass, in particular less than 30% by mass, less than 20% by mass, less than 10% by mass, or even less than 5% by mass, wherein for all the above ranges the lower limit may be about 10 ppm. However, in case of water as the other component the ranges may be between about 10 ppm and 50% by mass, in particular between about 10 ppm and 35% by mass, between about 10 ppm and 20% by mass, between about 10 ppm and 10% by mass, or even between about 10 ppm and 5% by mass. In this context it should be noted that according to specific embodiments the sorption may be performed by the ionic liquid itself, e.g. may particularly be a physical sorption. In general, the ionic liquid may also perform a chemical sorption, a physical sorption or a combined chemical-physical sorption. This process has to be distinguished from a process in which the ionic liquid only forms a solvent for a compound or component, e.g. a polymer, which then acts as the sorbent for the CO₂. That is, according to specific embodiments of the invention the ionic liquid may form the sorbent which sorbs the CO₂. Consequently a method according to an exemplary embodiment may comprise the step of sorbing CO₂ by an ionic liquid, wherein the ionic liquid may be a pure or substantially pure ionic liquid or may include some additives having only few, e.g. less than 35% by mass, further components. In the most generic form the ionic liquids may be represented by [Q⁺]ₐ[Aₐ⁻], wherein Q represents a non-aromatic cation and which may be produced by a process as described for example in WO 2005/021484 which is hereby herein incorporated by reference.

According to an exemplary aspect of the invention a device for sorption of CO₂ is provided, wherein the device comprises a reservoir of an ionic liquid comprising an anion and a non-aromatic cation.

In particular, the device may comprise an inlet, a container including the ionic liquid, and optionally an outlet. The device can be used to sorb CO₂ from flue gas.

The use of non-aromatic cations of the ionic liquid may provide for an ionic liquid which may be cheaper and more secure than the use of aromatic cations. Such ionic liquids may be a suitable medium to sorb CO₂ out of flue or off gases and may also be suitable to release CO₂ again. The CO₂ and the ionic liquid may form a complex, i.e. the CO₂ may be complex bound. According to some exemplary embodiments it may even be possible to remove the complex bound in the form of a solid compound. The uses of such ionic liquids for sorption of CO₂ may be advantageous since ionic liquids may be used showing no or at least substantially no vapor pressure, e.g. a non measureable vapor pressure or even a vapor pressure in the same magnitude of order of steel. Thus, the flue gas may not be contaminated by vapor of the ionic liquid. Furthermore, the use of non-aromatic ionic liquids may increase the performance of the sorption process compared to the case in which aromatic ionic liquids are used. For example, the removal process of CO₂ by using non-aromatic ionic liquids may exhibit an improved performance when removing the gases out of flue gas or off gas. In particular, the flue gas may originate from any industry plant needing or producing great amounts of heat and or energy, e.g. an electrical power plant or cement plant.

Next, further aspects of exemplary embodiments of the method for sorption of CO₂ are described. However, these embodiments apply for the device for sorption of CO₂ as well.

According to an exemplary embodiment of the method the non-aromatic cation is an aliphatic cation. The term “aliphatic cation” may also include cations having aliphatic side chains.

Aliphatic cations may be suitable non-aromatic cations for an ionic liquid which are less expensive and/or less toxic than typical aromatic cations.

According to an exemplary embodiment of the method the ionic liquid satisfy the generic formula [Q⁺][A⁻],

wherein the anion can be described by one of the following structures:

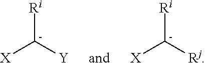

In particular, the anion may be describable by the resonant or mesomeric states:

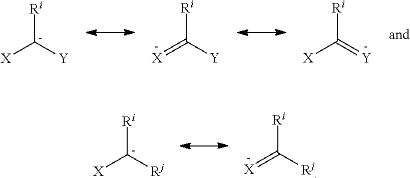

wherein X and Y may indicate, independently from each other, groups which may attract electrons due to the inductive effect or the mesomeric effect and/or which may delocalize and/or stabilize (localize) electrons. Examples for such groups may be:

—CN, —NO₂, —NO₃, —CO—R^{k}, —COOR^{k}, —C═N—R^{k}, —CO—NR^{k}R^{m}, —NR^{k}R^{m}, —OH, —OR^{k}, —SH, —SR^{k}, —SO—R^{k}, —SO₂—R^{k}, —SO₂—OR^{k}, —PO—OR^{k}OR^{m} (phosphonate), —I, —Cl, —Br, —F, —CCl₃, —CCl₂R^{k}, —CCIR^{k}R^{m}, —CF₃, —CF₂R^{k}, —CFR^{k}R^{m}, —SO₂CF₃, —COOCF₃, —C₆H₅, —CR^{k}═CR^{m}Rⁿ, —C≡CR^{m}, —CR^{k}═CR^{m}—CN, —CR^{k}═CR^{m}—NO₂, —CR^{k}═CR^{m}—CO—R^{k}, —CR^{k}═CR^{m}—COOR^{k}, —CR^{k}═CR^{m}—C═N—Rⁿ, —CR^{k}═CR^{m}—CO—NRⁿRo, —CR^{k}═CR^{m}—NRⁿR^{o}, —CR^{k}═CR^{m}—ORⁿ, —CR^{k}═CR^{m}—SRⁿ, —CR^{k}═CR^{m}—SO—Rⁿ, —CR^{k}═CR^{m}—SO₂—Rⁿ, —CR^{k}═CR^{m}—SO₂—Rⁿ, —CR^{k}═CR^{m}—SO₂ORⁿ, —CR^{k}═CR^{m}—CF3, —CR^{k}═CR^{m}—SO₂CF₃,

wherein R^{k}, R^{m}, Rⁿ, R^{o} may, independently from each other, denote hydrogen, C₁- to C₃₀-alkyl and their aryl-, heteroaryl-, cycloalkyl-, halogen-, hydroxy-, amino-, carboxy-, formyl-, —O—, —CO—, —CO—O— or —CO—N<substituted components, like methyl, ethyl, 1-propyl, 2-propyl, 1-butyl, 2-butyl, 2-methyl-1-propyl (isobutyl), 2-methyl-2-propyl (tert.-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3dimethyl-2-butyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, triacontyl, phenyl methyl (benzyl), diphenylmethyl, triphenylmethyl, 2-phenylethyl, 3-phenylpropyl, cyclopentylmethyl, 2-cyclopentylethyl, 3-cyclopentylpropyl, cyclohexylmethyl, 2-cyclohexylethyl, 3-cyclohexylpropyl, methoxy, ethoxy, formyl, acetyl or CₙF_{2(n-a)+(1-b)}H_{2a+b} wherein n≦30, 0≦a≦n and b=0 or 1 (e.g. CF₃, C₂F₅, CH₂CH₂—C₍ₙ₋₂₎F₂₍ₙ₋₂₎₊₁, C₆F₁₃, C₈F₁₇, C₁₀F₂₁, C₁₂F₂₅);

C₃- to C₁₂-cycloalkyl and their aryl-, heteroaryl-, cycloalkyl-, halogen-, hydroxy-, amino-, carboxy-, formyl-, —O—, —CO— or —CO—O-substituted components, e.g. cyclopentyl, 2-methyl-1-cyclopentyl, 3-methyl-1-cyclopentyl, cyclohexyl, 2-methyl-1-cyclohexyl, 3-methyl-1-cyclohexyl, 4-methyl-1-cyclohexyl or CₙF_{2(n-a)-(1-b)}H_{2a-b} wherein n≦0, 0≦a≦n and b=0 or 1;

C₂- to C₃₀-alkenyl and their aryl-, heteroaryl-, cycloalkyl-, halogen-, hydroxy-, amino-, carboxy-, formyl-, —O—, —CO— or —CO—O-substituted components, e.g. 2-propenyl, 3-butenyl, cis-2-butenyl, trans-2-butenyl or CₙF_{2(n-a)-(1-b)}H_{2a-b} wherein n≦30, 0≦a≦n and b=0 or 1;

C₃- to C₁₂-cycloalkenyl and their aryl-, heteroaryl-, cycloalkyl-, halogen-, hydroxy-, amino-, carboxy-, formyl-, —O—, —CO— or —CO—O-substituted components, e.g. 3-cyclopentenyl, 2-cyclohexenyl, 3-cyclohexenyl, 2,5-cyclohexadienyl or CₙF_{2(n-a)-3(1-b)}H_{2a-3b} wherein n≦0, 0≦a≦n and b=0 or 1; and

aryl or heteroaryl having 2 to 30 carbon atoms and their alkyl-, aryl-, heteroaryl-, cycloalkyl-, halogen-, hydroxy-, amino-, carboxy-, formyl-, —O—, —CO— or —CO—O-substituted components, e.g. phenyl, 2-methyl-phenyl (2-tolyl), 3-methyl-phenyl (3-tolyl), 4-methyl-phenyl, 2-ethyl-phenyl, 3-ethyl-phenyl, 4-ethyl-phenyl, 2,3-dimethyl-phenyl, 2,4-dimethyl-phenyl, 2,5-dimethyl-phenyl, 2,6-dimethyl-phenyl, 3,4-dimethyl-phenyl, 3,5-dimethyl-phenyl, 4-phenyl-phenyl, 1-naphthyl, 2-naphthyl, 1-pyrrolyl, 2-pyrrolyl, 3-pyrrolyl, 2-pyridinyl, 3-pyridinyl, 4-pyridinyl or C₆F₍₅₋ₐ₎Hₐ wherein 0≦a≦5,

wherein pairs of the R^{k}, R^{m}, Rⁿ, R^{o} may be bonded directly to each other or via C1-C4, which may be substituted if necessary, so that a saturated, unsaturated, or conjugated unsaturated ring may be formed.

According to an exemplary embodiment of the method the ionic liquid satisfy the generic formula [Q⁺]ₐ[A^{a-}], wherein [A^{a-}] is selected out of the group consisting of:

dialkyl ketones, dialkyl-1,3-diketones, alkyl-β-keto esters, terminal alkines, linear or cyclic 1,3-thioethers, dialkyl phosphonates, dialkyl malonic acid esters, β-cyano carbonic acids and their respective alkylesteres, β-alkoxy carbonic acids and their respective alkylesters, β-cyano nitriles, cyclopentadiene (substituted if necessary), trialkylimines, dialkylimines, diaryl ketones, alkyl-aryl-ketones, diaryl-1,3-diketones, alkyl-aryl-1,3-diketones, β-aryloxy carbonic acids and their respective alkylesters, β-aryloxy carbonic acids and their respective arylesters, aryl-β-ketoesters, diarylphosphonates, alkyl-aryl-phosphonates, diaryl malonic acid esters, alkyl-aryl-malonic acid esters, β-cyano carbonic acids arylesteres and arylimines.

According to an exemplary embodiment of the method the ionic liquid satisfy the generic formula [Q⁺]ₐ[A^{a-}], wherein [A^{a-}] is a carbanion formed by deprotonating a chemical compound selected out of the group consisting of:

acetoacetic ester, malonic mononitrile, malonic acid dimethylester, malonic acid diethylester, acetylacetone, malonic acid dinitrile, acetone, diethylketone, methlethylketone, dibutylketone, 1,3-dithian, acetaldehyde, benzaldehyde, crotonaldehyde and butyraldehyde.

According to an exemplary embodiment of the method the non-aromatic cation is a quaternary material. In particular, the quaternary material may be a quaternary salt. Alternatively, the non-aromatic cation may comprise or may consist of protonated bases.

According to an exemplary embodiment of the method the anion comprises a carbonate, carboxylate, a carbanion, and/or an aromatic compound.

According to an exemplary embodiment of the method the anion comprises at least one polar group.

In particular, the polar group may be formed by an acetate, a sulfonate, a sulfate, a carbonate, and/or a malonate compound. Furthermore, it should be noted that the anion may be polar. In particular, the anion may be formed by a small ion having a high charge density or by an ion, carrying a functional group with a heteroatom with a high charge density e.g. O, N, F.

According to an exemplary embodiment of the method the cation is a quaternary or protonated cation out of the group consisting of ammonium, phosphonium, sulfonium, piperidinium, pyrrolidinium and morpholinium.

According to an exemplary embodiment of the method the cation is one out of the group consisting of trialkylmethylammonium, tetramethylammonium, triethylmethylammonium, tributylmethylammonium, and trioctylmethylammonium, trialkylammonium, trimethylammonium, triethylammonium, tributylammonium, and trioctylammonium. In particular, the trialkylmethylammonium may be a C1-C10-trialkylmethylammonium.

According to an exemplary embodiment of the method the cation is one out of the group consisting of tetramethylammonium, triethylmethylammonium, tributylmethylammonium, and trioctylmethylammonium.

According to an exemplary embodiment of the method the anion can be written in the form [RCO₂⁻], wherein [RCO₂⁻] is one out of the group consisting of carboxylate, formiate, acetate, propionate, butyrate, benzoate, and salicylate.

According to an exemplary embodiment of the method of the anion can be written in the form [RCO₂⁻], wherein [RCO₂⁻] is a carboxylate and wherein R is a radical out of the group consisting of C1-C30-alkyl, C3-C12-cycloalkyl, C2-C30-alkenyl, C3-C12-cycloalkenyl, C2-C30-alkinyl, aryl and heteroaryl. In particular, the moiety or radical R may comprise or include one or more halogen radicals.

According to an exemplary embodiment of the method the anion can be written in the form [RCO₂⁻], wherein [RCO₂⁻] is a carboxylate wherein R represents one to three radicals out of the group consisting of, C1-C6-alkyl, aryl, heteroaryl, C3-C7-cycloalkyl, halogen, cyanide, ORc, SRc, NRcRd, CORc, COORc, CO—NRcRd, wherein Rc and/or Rd, is one of the group consisting of hydrogen, C1-C6-alkyl, C1-C6-halogenalkyl, cyclopentyl, cyclohexyl, phenyl, tolyl, and benzyl.

According to an exemplary embodiment of the method the anion can be written in the form [RCO₃⁻], wherein [RCO₃⁻] is a carbonate wherein R represents one to three radicals out of the group consisting of, hydrogen, C1-C6-alkyl, aryl, heteroaryl, C3-C7-cycloalkyl, halogen, cyanide, ORc, SRc, NRcRd, CORc, COORc, CO—NRcRd, wherein Rc and/or Rd, is one of the group consisting of hydrogen, C1-C6-alkyl, C1-C6-halogenalkyl, cyclopentyl, cyclohexyl, phenyl, tolyl, and benzyl. Alternatively, the anion may be carbonate, i.e. CO₃²⁻.

According to an exemplary embodiment of the method the anion is choline carbonate. By sorbing CO₂ the choline carbonate (CAS 59612-50-9) may form choline hydrogencarbonate (CAS 78-73-9). The choline hydrogencarbonate may be regenerated to choline carbonate again by heating the same.

Summarizing, according to an exemplary aspect of the invention, a method of use is provided which uses an ionic liquid having a non-aromatic cation to sorb CO₂, having an electric multipole moment, out of flue gas or off gas. The ionic liquid may be an organic salt having a melting temperature of below 200° C., preferably below 100° C. The organic salts may be quaternary salts having a generic formula of: [Q⁺][RCO₂⁻] or [Q⁺][RCO₃⁻] or [Q⁺][RⁱXYC⁻] or [Q⁺] [RⁱR^{j}XC⁻]. The described method can be in particular useful for all processes in which CO₂ shall be removed from flue gas. Furthermore, it may be possible to use ionic liquids which selectively remove CO2 while do not remove water or water vapor, i.e. hydrophobic ionic liquids may be used.

The aspects defined above and further aspects of the invention are apparent from the examples of embodiment to be described hereinafter and are explained with reference to these examples of embodiment. It should be noted that features described in connection with one exemplary embodiment or exemplary aspect may be combined with other exemplary embodiments and other exemplary aspects.

### BRIEF DESCRIPTION OF THE DRAWINGS

The invention will be described in more detail hereinafter with reference to examples of embodiment but to which the invention is not limited.

FIG. 1 schematically illustrates a power plant.

FIG. 2 schematically illustrates a test arrangement for measuring a gas sorption.

FIG. 3 schematically illustrates a test arrangement for measuring equilibrium curves.

FIG. 4 illustrates equilibrium curves for monoethanolamine.

FIG. 5 illustrates equilibrium curves for choline carbonate.

### DESCRIPTION OF EMBODIMENTS

The illustration in the drawing is shown schematically.

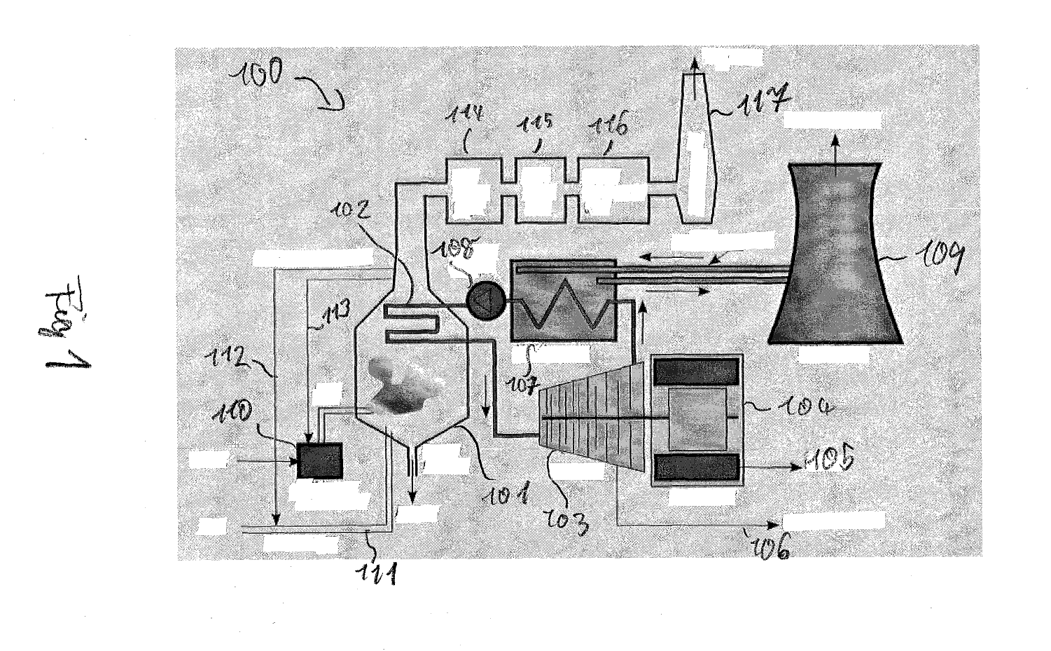

FIG. 1 schematically shows a power plant which may use a process according to an exemplary embodiment, i.e. a process for removing CO₂ out of flue gas by using an ionic liquid comprising a non-aromatic ionic liquid.

In particular, FIG. 1 shows a power plant 100 comprising a combustor 101 in which oil, gas or coal can be burned. The power plant further comprises a heat exchange unit which is schematically indicated by pipes 102 which are connected to a turbine 103 in which loaded steam is unloaded to drive the turbine and a generator 104 connected to the turbine in order to generate electric power indicated by arrow 105. Furthermore, heat for district heating may be withdrawn which is indicated by arrow 106. The unloaded steam is then inputted in a condenser 107 and the resulting water is then pumped by pump 108 back to the heat exchanging unit 102. For cooling the steam the condenser 107 may be coupled to a cooling tower 109 or river water may be used.

Furthermore, the power plant comprises a crusher and drying unit 110 which crushes and dries coal which is then introduced into the combustor. Additionally, air is fed into the combustor which is indicated by lines 111. Preferably, the air is pre-heated which is indicated by arrow 112. The pre-heating of the air as well as the drying of the coal residual heat of exhaust or flue gases of the combustor may be used, which is indicated by the arrow 113. The flue gas produced by burning the coal in the combustor 101 is released to the environment. However, before the flue gas is uncharged a first cleaning unit 114 removes dust, while a second cleaning unit 115 removes sulphur oxides and nitrogen oxides. A third cleaning unit 116 is used to remove at least parts of the carbon dioxide by using an ionic liquid. Afterwards the flue gas is emitted through a stack 117.

In the following some experimental results are described showing the ability of ionic liquid to absorb CO₂.

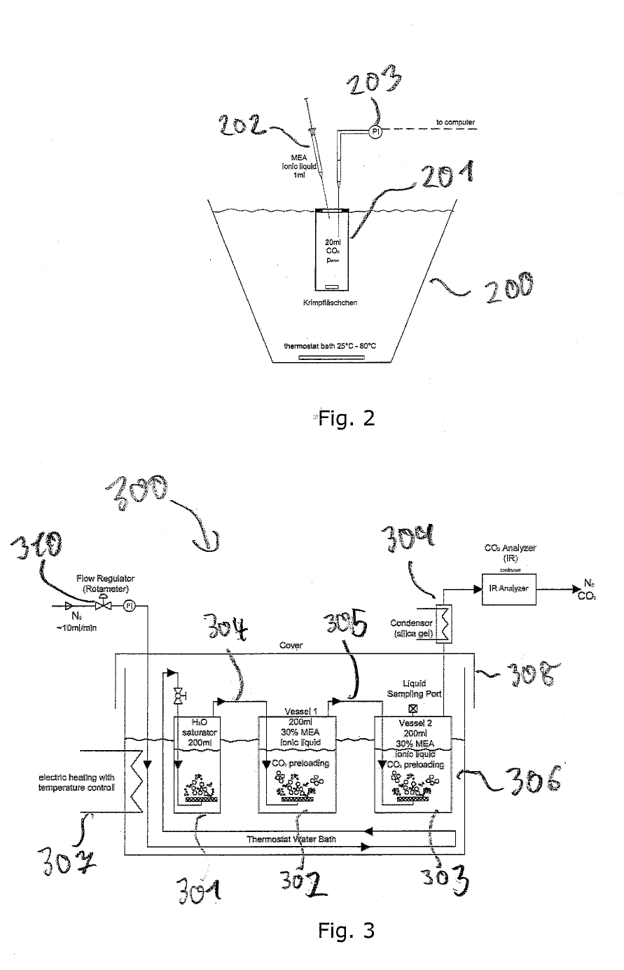

FIG. 2 schematically shows a water bath 200 used as a heat reservoir in order to provide a constant temperature selectable in the range between 25° C. and 80° C. A vessel or vial 201 having a volume of about 20 ml is placed in the bath, wherein the vial is filled with CO₂ at a partial pressure of the environmental pressure, e.g. atmospheric pressure of about 1000 hPa. Additionally, a CO₂ sorbing fluid is injected 202 into the vial. The sorption of the CO₂ is determined by measuring the decrease of the pressure in the vial by a digital manometer 203 which is connected to a computer. The speed of the pressure decrease is an indicator of the reaction kinetics and the total decrease of the pressure is an indicator for the total CO₂ sorption. The tests were performed at two temperatures 25° C. and 80° C., wherein at the higher temperature a smaller amount of CO₂ sorption may be desirable since this may be an indicator for an estimation of the ability of the fluid to release the CO₂. For testing several ionic liquids are injected and compared to a reference sample, wherein an aqueous solution (30%) of monoethanolamine is used. In particular, the resulting parameter was the equilibrium concentration at constant reduced pressure, i.e. the pressure reached in the vial at the set temperature, wherein the result was calculated in mol_{gas} per mol_{IL}, wherein the index gas denotes CO₂ and the index IL denotes ionic liquid. The equilibrium concentration was calculated by the following formular:

$$\frac{pressure decrease [ hPa ] \cdot 0.02145 [ l ]}{83.145 \cdot [ {10}^{- j} kJ \text{/} K \cdot mol ] \cdot temp [ K ]} / \frac{mass of {CO}_{2} [ g ]}{molar mass of {CO}_{2} [ g \text{/} mol ]}$$

wherein 0.02145 is the volume of the vial and 83.145 is the gas constant in the used units.

The following results were achieved:

| | | | | | | loading |
|---|---|---|---|---|---|---|
| | | conc. | T | pressure | time | [mol_{CO2}/ |
| name | solvent | [% wt] | [° C.] | decrease | [min] | mol_{IL}] |
| TBMP-acetate | | 100 | 25 | 332 | 4000 | 0.08 |
| TBMP-acetate | | 100 | 80 | 342 | 3160 | 0.08 |
| TEMA-acetate | H₂O | 70 | 25 | 495 | 2400 | 0.1 |
| TEMA-acetate | H₂O | 70 | 80 | 130 | 2400 | 0.03 |
| TOMA- | | 100 | 25 | 448 | 2500 | 0.19 |
| TOMA- | | 100 | 80 | 122 | 1000 | 0.05 |
| MEA | H₂O | 30 | 25 | 679 | 250 | 0.12 |
| MEA | H₂O | 30 | 80 | 440 | 130 | 0.08 |

### Wherein:

TBMP denotes tributyl methyl phosphonium,
TEMA denotes triethyl methyl ammonium,
TOMA denotes trioctyl methyl ammonium, and
MEA denotes monoethanolamine.

Obviously the acetate anion may be responsible for a high CO₂ sorption, while similar sorption amounts may be achievable by cations having different structures.

FIG. 3 schematically illustrates a test arrangement 300 for measuring equilibrium curves. In particular, FIG. 3 shows an equilibrium cell comprising three vessels 301, 302 and 303 each closed by a respective frit in order to ensure a good mass transfer between the CO₂ and the sorption fluid. The vessels are connected by flexible plastic tubes 304 and 305 having non-return valves. The vessels are placed in a heat reservoir 306 to ensure a constant temperature which can be controlled by using an electric heating 307. The heat reservoir is closed by a cover or lid 308 in order to assure the temperature control. A container or condenser 309 including silica gel is implemented downstream of the equilibrium cell wherein the silica gel is used to dry the generated gas which is then analyzed. Additionally, the input amount or volume to the equilibrium cell is controlled or regulated by using a rotameter 310.

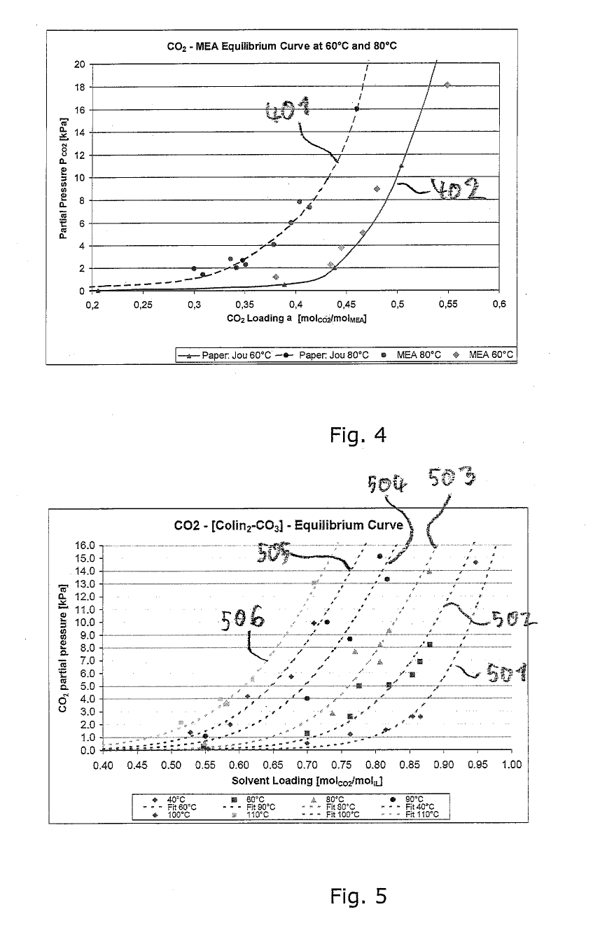

FIG. 4 illustrates equilibrium curves for monoethanolamine. In particular, FIG. 4 shows the partial pressure p_{CO2} versus the CO₂ loading for 60° C. and 80° C. for an aqueous solution (30%) of monoethanolamine. For each temperature a respective curve is approximated based on measurements, wherein a first curve 401 approximates the equilibrium curve for 80° C. while a second curve 402 approximates the equilibrium curve for 60° C. The results are in good accordance with the state of the art data published in literature, well known to experts in the field. The test arrangement described in FIG. 3 therefore seems to be reasonable.

FIG. 5 illustrates equilibrium curves for choline carbonate. In particular, FIG. 5 shows values for the partial pressure p_{CO2} versus the CO₂ loading for six different temperatures 40° C., 60° C., 80° C., 90° C., 100° C., and 110° C. for an aqueous solution (60%) of choline carbonate. Additionally, the measured values fits for the different temperatures are shown in FIG. 5 as well. In particular, graph 501 shows the fit for 40° C., graph 502 shows the fit for 60° C., graph 503 shows the fit for 80° C., graph 504 shows the fit for 90° C., graph 505 shows the fit for 100° C., and graph 506 shows the fit for 110° C.

Furthermore, an experiment concerning the influence of water on the CO₂ sorption was performed. TEMA acetate having a water amount of 10% was used as an ionic liquid. TEMA acetate was contacted for four days with a CO₂ atmosphere having a pressure of 600 hPa at a temperature of 80° C. In one case the TEMA acetate included a surplus of water while in the other case no water was added. The water content of the sample including water increased from 10% to 35% while the sample without water increased only from 0% to 15%. After the four days acid was added to the two samples which lead to a clear generation of foam or gas in the sample without water, while the reaction of the probe with water was less intense. Thus, the water may lead to a reduced CO₂ sorption of the ionic liquid.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The terms “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. Method for sorption of CO₂ out of flue gas, the method comprising:
contacting the flue gas and an ionic liquid comprising an anion and a non-aromatic cation.

2. Method according to claim 1,
wherein the non-aromatic cation is an aliphatic cation.

3. Method according to claim 1,
wherein the non-aromatic cation is a quaternary material.

4. Method according to claim,
wherein the anion comprises a carbonate, a carboxylate, a carbanion, and/or an aromatic compound.

5. Method according to claim 1:
wherein the ionic liquid satisfy the generic formula [Q⁺][A⁻],
wherein the anion can be described by one of the following structures:

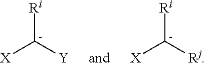

6. Method according to claim 1,
wherein the ionic liquid satisfy the generic formula [Q⁺]ₐ[A^{a-}],
wherein [A^{a-}] is selected out of the group consisting of:
dialkyl ketones, dialkyl-1,3-diketones, alkyl-β-keto esters, terminal alkines, linear or cyclic 1,3-thioethers, dialkyl phosphonates, dialkyl malonic acid esters, β-cyano carbonic acids and their respective alkylesteres, β-alkoxy carbonic acids and their respective alkylesters, β-cyano nitriles, cyclopentadiene (substituted if necessary), trialkylimines, dialkylimines, diaryl ketones, alkyl-aryl-ketones, diaryl-1,3-diketones, alkyl-aryl-1,3-diketones, β-aryloxy carbonic acids and their respective alkylesters, β-aryloxy carbonic acids and their respective arylesters, aryl-β-ketoesters, diarylphosphonates, alkyl-aryl-phosphonates, diaryl malonic acid esters, alkyl-aryl-malonic acid esters, β-cyano carbonic acids arylesteres and arylimines.

7. Method according to claim 1,
wherein the ionic liquid satisfy the generic formula [Q⁺]ₐ[A^{a-}],
wherein [A^{a-}] is a carbanion formed by deprotonating a chemical compound out of the group consisting of:
acetoacetic ester, malonic mononitrile, malonic acid dimethylester, malonic acid diethylester, acetylacetone, malonic acid dinitrile, acetone, diethylketone, methlethylketone, dibutylketone, 1,3-dithian, acetaldehyde, benzaldehyde, crotonaldehyde and butyraldehyde.

8. Method according to claim 1,
wherein the anion comprises at least one polar group.

9. Method according to claim 1,
wherein the cation is a quaternary or protonated cation out of the group consisting of:
ammonium, phosphonium, sulfonium, piperidinium, and morpholinium.

10. Method according to claim 1,
wherein the cation is one out of the group consisting of:
trialkylmethylammonium, tetramethylammonium, triethylmethylammonium, tributylmethylammonium, trioctylmethylammonium trialkylammonium, trimethylammonium, triethylammonium, tributylammonium, and trioctylammonium.

11. Method according to claim 1,
wherein the cation is one out of the group consisting of:
tetramethylammonium, triethylmethylammonium, tributylmethylammonium, and trioctylmethylammonium.

12. Method according to claim 1,
wherein the anion can be written in the form [RCO₂⁻],
wherein [RCO₂⁻] is one out of the group consisting of:
carboxylate, formiate, acetate, propionate, butyrate, benzoate, and salicylate.

13. Method according to claim 1,
wherein the anion can be written in the form [RCO₂⁻],
wherein [RCO₂⁻] is a carboxylate wherein R is a radical out of the group consisting of:
C1-C30-alkyl, C3-C12-cycloalkyl, C2-C30-alkenyl, C3-C12-cycloalkenyl, C2-C30-alkinyl, aryl and heteroaryl.

14. Method according to claim 1,
wherein the anion can be written in the form [RCO₂⁻],
wherein [RCO₂⁻] is a carboxylate wherein R represents one to three radicals out of the group consisting of:
C1-C6-alkyl, aryl, heteroaryl, C3-C7-cycloalkyl, halogen, cyanide, ORc, SRc, NRcRd, CORc, COORc, CO—NRcRd,
wherein Rc and/or Rd, is one of the group consisting of:
hydrogen, C1-C6-alkyl, C1-C6-halogenalkyl, cyclopentyl, cyclohexyl, phenyl, tolyl, and benzyl.

15. Method according to claim 1,
wherein the anion can be written in the form [RCO₃⁻],
wherein [RCO₃⁻] is a carbonate wherein R represents one to three radicals out of the group consisting of:
hydrogen, C1-C6-alkyl, aryl, heteroaryl, C3-C7-cycloalkyl, halogen, cyanide, ORc, SRc, NRcRd, CORc, COORc, CO—NRcRd,
wherein Rc and/or Rd, is one of the group consisting of:
hydrogen, C1-C6-alkyl, C1-C6-halogenalkyl, cyclopentyl, cyclohexyl, phenyl, tolyl, and benzyl.

16. Method according to claim 15,
wherein the anion is choline carbonate.

17. Device for sorption of CO₂ having an electric multipole moment, the device comprising:
a reservoir of an ionic liquid comprising an anion and a non-aromatic cation.
